(19) United States
(12) Patent Application Publication
(10) Pub. No.: US 2013/0111323 A1
(43) Pub. Date: May 2, 2013

(54) Survey System

(71) Applicant: PopSurvey LLC, Needham, MA (US)

(72) Inventors: Siamak Taghaddos, Cambridge, MA (US); Joshua G. Pigford, Birmingham, AL (US)

(73) Assignee: PopSurvey LLC, Needham, MA (US)

(21) Appl. No.: 13/664,368

(22) Filed: Oct. 30, 2012

Related U.S. Application Data
(60) Provisional application No. 61/628,520, filed on Oct. 31, 2011.
(60) Provisional application No. 61/587,210, filed on Jan. 17, 2012.

(51) Int. Cl. G06F 17/24

(52) U.S. Cl. 715/223

(57) ABSTRACT

A method, apparatus and computer program product for creating, editing and displaying surveys is presented. Techniques include receiving a request to create a survey from a survey creator, providing a plurality of survey question types, providing a graphical user interface for composing survey questions using at least one of the plurality of survey question templates, providing a graphical user interface for editing the survey questions in response to input from the survey creator and displaying the edited survey questions on a survey player.

### BACKGROUND

For as long as surveys have existed, they have generally been a long form or multiple pages of forms with questions and answer choices. These surveys are very similar to grade school exams. With the invention of the World Wide Web, online survey tools have simply continued this traditional survey method by letting survey creators build these forms online to let survey takers complete them. FIG. 1 shows a conventional survey having a standard list of questions and selectable answers in a list format.

Surveys are used for feedback of an experience (e.g., a purchase, research on future products, a product return and unsubscribing from a mailing list). It is sometimes difficult to obtain useful information and high participation rates from conventional surveys similar to the survey in FIG. 1. One major bottleneck for users is distributing their survey out via email. Currently, sending a survey to more than a few people requires the use of a third-party newsletter service (e.g., MailChimp, Campaign Monitor, Constant Contact, etc.). The user has to deal with importing user lists, designing a newsletter and worrying about numerous settings just to send out a quick email to promote a survey. In some conventional survey systems the skip-logic and branching functionality is typically complex. This complexity increases the difficulty in both creating and taking a survey.

It would be useful to have a survey system which facilitates the creation, distribution and analysis of surveys and which also encourages a high participation from customers and other survey takers.

### SUMMARY

The survey system as described in embodiments herein is different from conventional online survey systems in both the way survey creators (SCs) build surveys and survey takers (STs) complete them. Surveys are displayed on a survey player with a single question displayed at a time for simplicity. These surveys are created one question at a time using a select number of question types, including for example one-click smileys.

Embodiments of the invention significantly overcome conventional deficiencies and provide a survey system that includes a database comprising plurality of survey question types, a survey editor, and a survey player. Such a system makes it easy as possible quickly create and distribute surveys. This enables a user to produce more surveys and receive more feedback sooner that with conventional survey systems.

In a first particular embodiment of a method for survey creation and distribution, the method includes receiving a request to create a survey from a survey creator, providing a plurality of survey question types, and providing a graphical user interface for composing survey questions using at least one of the plurality of survey question types. The method further includes providing a graphical user interface for editing the survey questions in response to input from the survey creator and displaying the edited survey questions on a survey player. Such techniques provide user friendly survey creation and editing tools and surveys with high participation rates.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations that receive a request to create a survey from a survey creator, provide a plurality of survey question templates, provide a graphical user interface for composing survey questions using at least one of the plurality of survey question templates, provide a graphical user interface for editing the survey questions in response to input from the survey creator and play the edited survey questions on a survey player.

The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers or on one computer alone.

It is to be understood that the embodiments of the invention can be embodied strictly as a software program, as software and hardware, or as hardware and/or circuitry alone, such as within a data communications device. The features of the invention, as explained herein, may be employed in software systems such as those manufactured by

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of embodiments of the invention, as illustrated in the accompanying drawings in which like reference characters refer to the same parts throughout the different views. The drawings are not necessarily to scale, emphasis instead being placed upon illustrating the principles of the invention.

FIG. 1 depicts a portion of a prior art survey including multiple question on one screen display;

FIG. 2 is a block diagram illustrating an exemplary architecture of a computer system in a computer/network environment according to embodiments herein;

FIG. 3 is a screen shot of a survey editor which enables a survey creator (SC) to compose survey questions in accordance with embodiments of the invention;

FIG. 4A is a screen shot of a template selection page of the survey editor of FIG. 3;

FIG. 4B is a screen shot of a question type selection page of the survey editor of FIG. 3;

FIGS. 5A and 5B are screen shots of question design screens of the survey editor of FIG. 3;

FIG. 5C is a screen shot of intro screen with user branding in accordance with embodiments of the invention;

FIG. 6A is a screen shot of a dashboard control screen which enables a survey creator

(SC) to edit, promote, receive notifications and to review responses from a survey in accordance with embodiments of the invention;

FIG. 6B is a screen shot of a survey promotion control screen which enables a survey creator (SC) to promote an edited survey in accordance with embodiments of the invention;

FIG. 7 is a screen shot of a survey response page which enables a survey creator (SC) to view survey responses in accordance with embodiments of the invention;

FIG. 8 is a screen shot of a question template used in conjunction with of the survey editor of FIG. 3;

FIGS. 9 and 10 are screen shots of survey questions as displayed on the survey player of FIG. 2;

FIGS. 11A and 11B are screen shots of survey questions as displayed on a mobile device using a survey player similar to the survey player of FIG. 2;

FIG. 12 is a screen shot of a rules control screen which enables a survey creator (SC) to implement in accordance with embodiments of the invention;

FIG. 13 is a screen shot of a survey response control page which enables the SC to view survey responses and select survey response options in accordance with embodiments of the invention;

FIG. 14 is a screen shot of a public survey response enabled on the a survey response control page of FIG. 13; and

FIG. 15 is a screen shot of a survey email control page which enables the SC to mail a survey link to a list of recipients in accordance with embodiments of the invention.

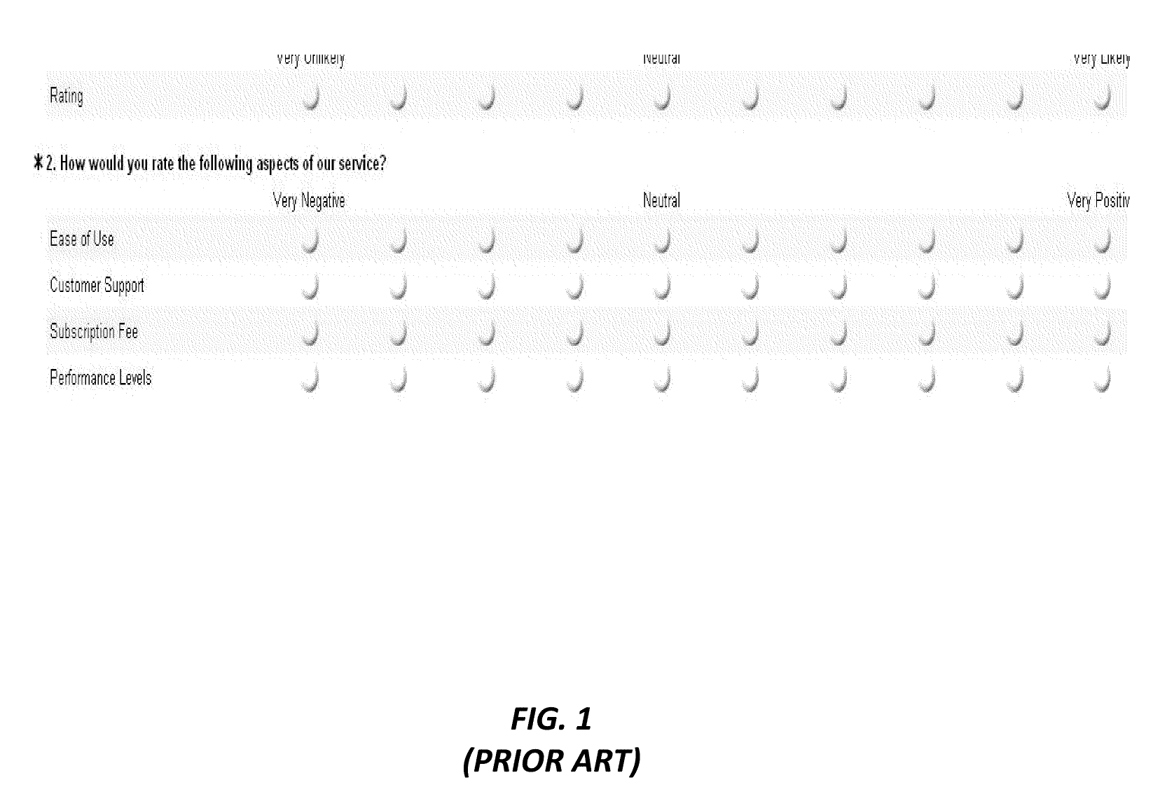

### DETAILED DESCRIPTION

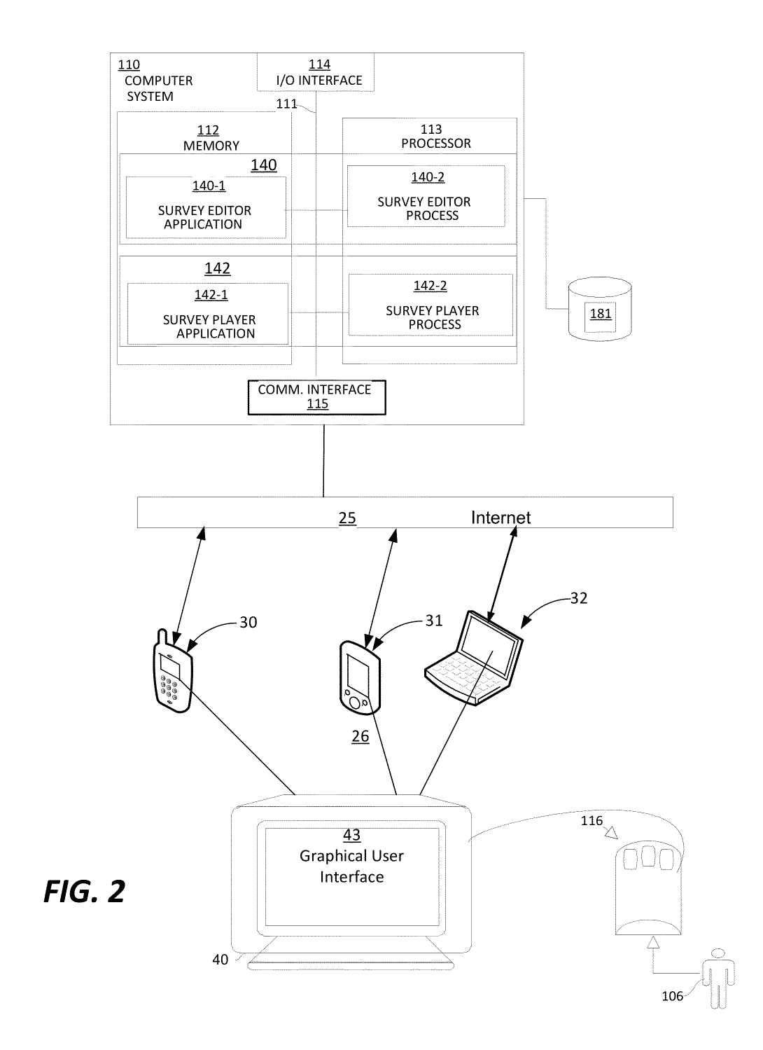

The inventors have discovered that it is important to balance the number of features, question types, and options in order to keep the survey editing tools usable and the survey taking experience conducive to high participation rates. Referring now to FIG. 2, a survey system 110 is shown that is useful for creating, editing and distributing online surveys. The survey system 110 includes a survey editor 140 including a survey editor application 140-land a survey editor process 140-2; and a survey player 142 including a survey player application 142-1 and a survey player process 142-2. FIG. 2 is an exemplary block diagram illustrating an architecture of a survey system 110 that executes, runs, interprets, operates or otherwise performs the survey editor process 140-2 (e.g. an executing version of the survey editor application 140-1) and the survey player process 142-2 (e.g. an executing version of the survey player application 142-1). In one embodiment, the survey editor is accessed by user 106 using devices connected via the Internet 25. The devices are for example, a data enabled mobile phone 30 (e.g. smart phone), a data enabled tablet 31 a desktop personal computer 32 and other data enabled devices (not shown) such as a laptop and a netbook. A user can access the survey player 142 through similar devices. If so configured, a display 40 on these devices can be used to present a graphical user interface 43 of the survey system 110 to user 106. An input device 116 (e.g., one or more user/developer controlled devices such as a keyboard, mouse, touch pad, touch sensitive screen, devices without keypads, speech input etc.) couples to the graphical user interface 43 to provide input to the survey editor 140 and survey player 142 of the survey system 110.

Note that the survey system 110 may be any type of computerized device such as a personal computer, a server computer system, workstation, portable computing device, console, laptop, netbook, television set-top box, camera, camcorder, network terminal, embedded processor, etc. This list is not exhaustive and is provided as an example of different possible embodiments. In addition to a single computer embodiment, survey system 110 can include any number of computer systems in a network environment to carry the embodiments as described herein. Thus, those skilled in the art will understand that the survey system 110 can include other processes and/or software and hardware components, such as an operating system that controls allocation and use of hardware resources, or multiple processors.

As shown in the present example, the survey system 110 includes an interconnection mechanism 111 such as a data bus, motherboard or other circuitry that couples a memory system 112, a processor 113, an input/output interface 114, and a display 40. Database 181 can optionally be used for storing survey templates and user survey and account information. The survey system 110 can be a client system and/or a server system. As mentioned above, depending on the embodiment, the survey editor application 140-1 and/or the survey editor process 140-2 can be distributed and executed in multiple nodes in a computer network environment, executed as a web application or performed locally on a single computer.

During operation of the survey system 110, the processor 113 accesses the memory system 112 via the interconnect 111 in order to launch, run, execute, interpret or otherwise perform the logic instructions of the survey player application 142-1. Execution of the survey editor application 140-1 and the application 142-1 in this manner produces the survey editor process 140-2 and the survey player process 142-2. In other words, the survey player process 142-2 represents one or more portions or runtime instances of the survey player application 142-1 (or the entire survey player application 142-1) performing or executing within or upon the processor 113 in the survey system 110 at runtime.

The survey editor application 140-1 and survey player application 142-1 may be stored on a computer readable medium (such as a floppy disk), hard disk, and electronic, magnetic, optical, or other computer readable medium. It is understood that embodiments and techniques discussed herein are well suited for other applications as well. Those skilled in the art will understand that the survey system 110 may include other processes and/or software and hardware components, such as an operating system. Display 40 need not be coupled directly to survey system 110. For example, the survey editor application 140-1 and survey player application 142-1 can be executed on a remotely accessible computerized device via the communication interface 115. The display 40 presents a rendered graphical user interface 43 that provides access to the survey editor 140 and survey player 142.

Note that the following discussion provides a basic embodiment indicating how to carry out functionality associated with the survey editor 140-1 and survey player 142-1 applications as discussed above and below. However, it should be noted that the actual configuration for carrying out the survey editor 140-1 and survey player 142-1 applications could vary depending on a respective application.

In operation, an account owner signs up for an account on a web site associated with the survey system 110, choosing one of several plans depending on his or her needs. Creation of an account allows the account owner to designate an SC (also referred to as a user) to revisit the site and view the surveys which have been created and to view results of the surveys that have been published/promoted and for which Survey Takers (ST) have taken. Different plans include a higher number of responses and additional features. Upon account creation, the user's account is saved in the database 181, along with pertinent account information so he or she can log back as needed.

The account owner has the ability to add additional users to their account depending on what plan they've selected. These users then have the ability to create/manage surveys under the same account. The typical use case for this is a single business that wants multiple employees to be able to use the same account. Additional users are associated in the database with the main account owner.

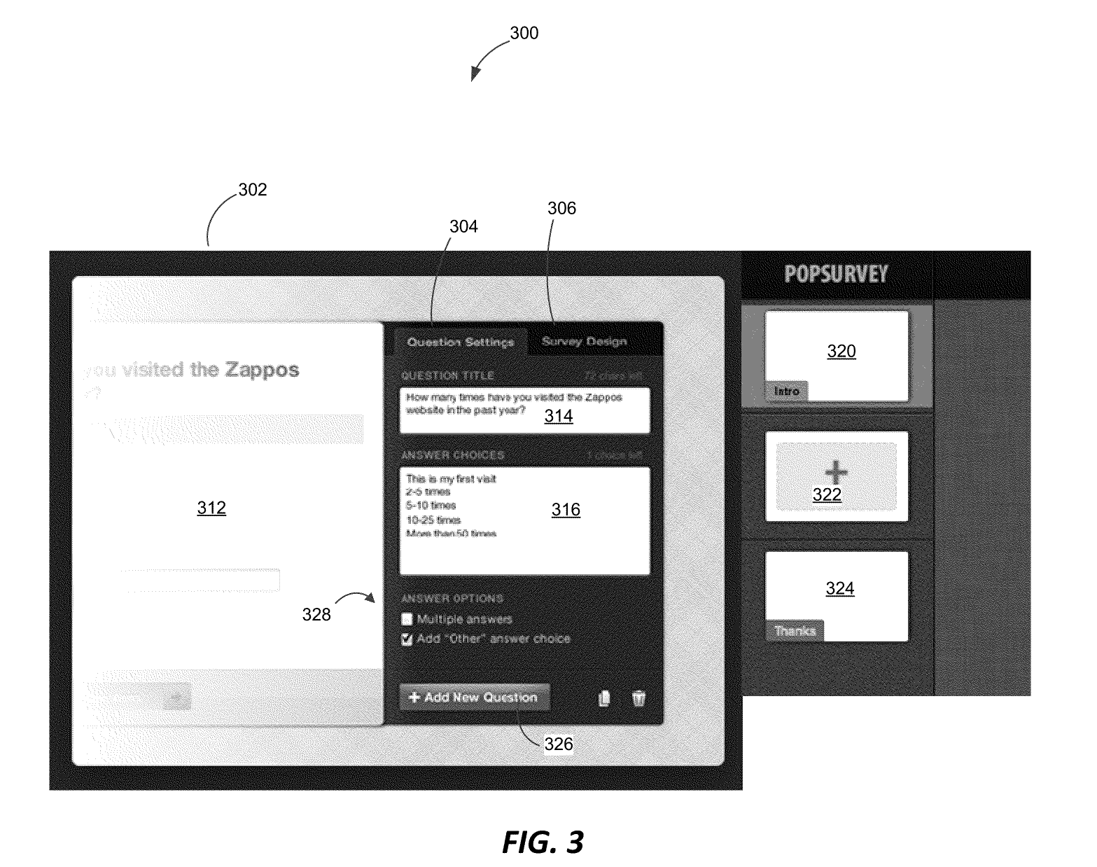

Now referring to FIG. 3 the survey editor 140 enables a survey creator (SC) to compose survey questions in accordance with embodiments of the invention. Once an account is created, the SC then creates their survey using the survey editor 140. In one embodiment as shown in screen shot 300, the survey editor 140 has question slides on the left where the SC can navigate through questions as well as rearrange them.

Upon completing survey creation, the survey, survey settings, questions and possible answers are stored separately in the database 181. The survey is also periodically saved automatically. It can also be saved manually via a “Save Now” button (not shown).

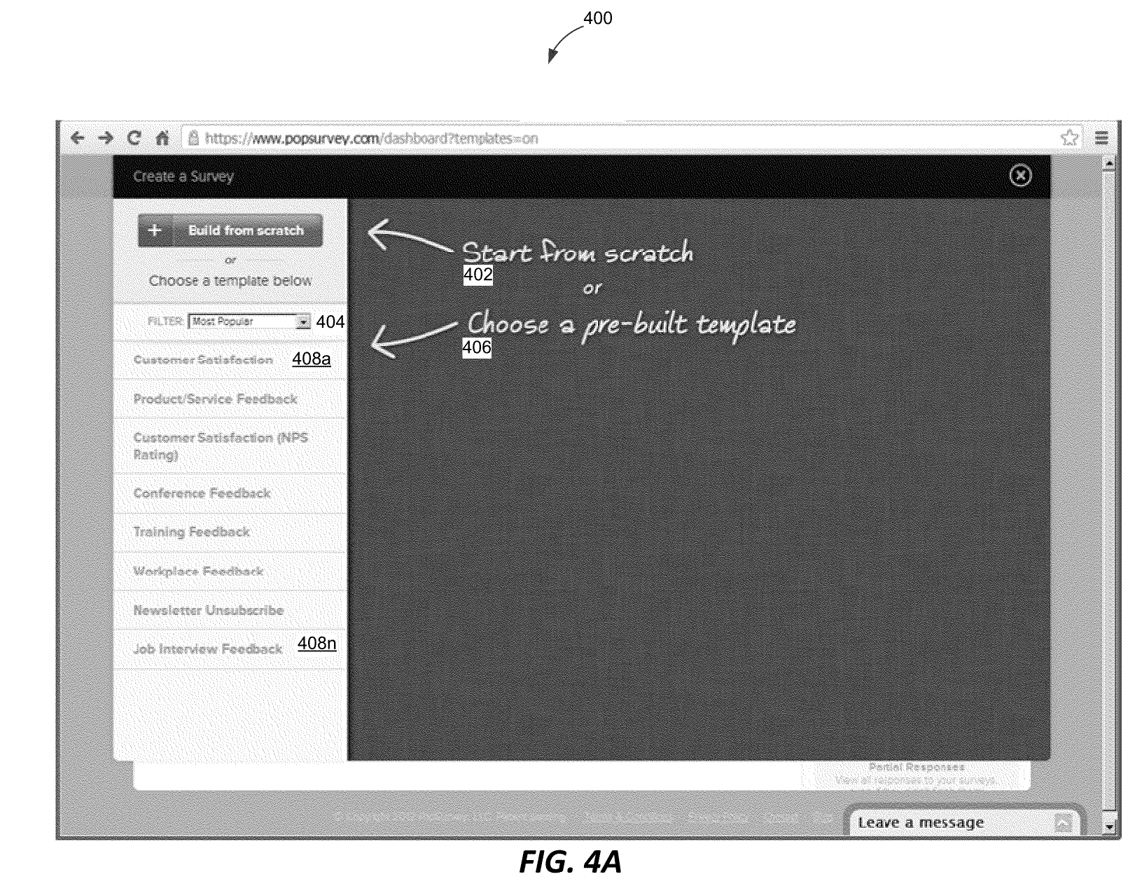

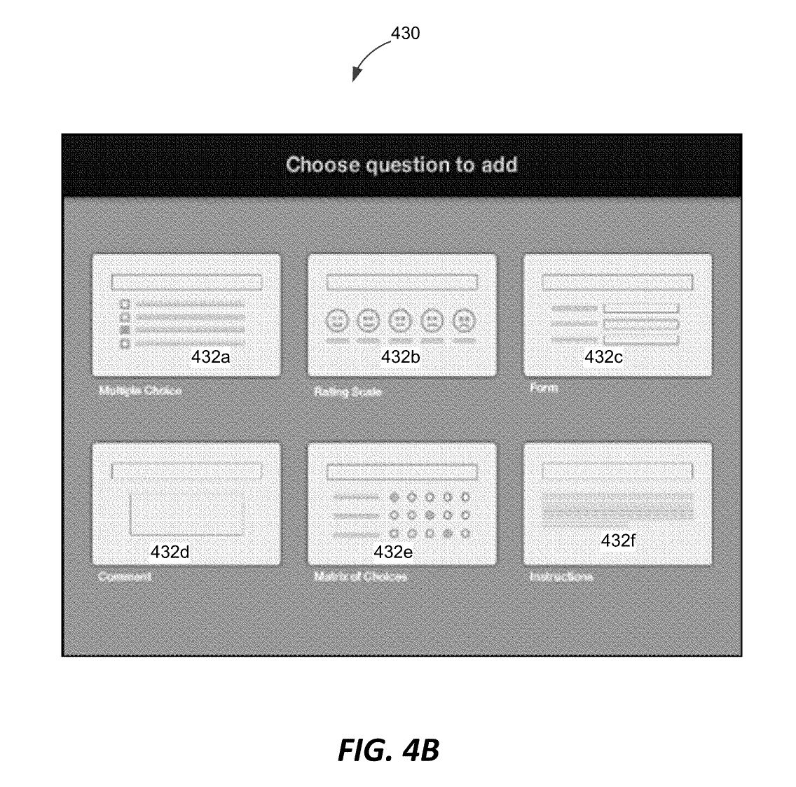

The intro slide 320 and thank you slide 324 have additional features for branding and customization such as uploading a logo and changing certain color elements. Each slide has a settings tab 304 where the question can be edited. To add a new question, the SC simply clicks on the “+” 322 or “Add a new question” button 326 and is given a choice of question types to choose from. To simplify the survey creation process, in some embodiments, the survey editor 140 presents one question at a time to the SC for editing. In operation, the SC selects a “+” symbol button 322 to add questions. In response, the survey editor provides a list of selectable question formats as shown in FIG. 4. In other embodiments, the survey editor 140 limits the number of answer options on multiple choice questions per survey question to a predetermined number (e.g., 5) and limits the length of survey answers (e.g., 420 characters).

The SC is able to provide a question title for the currently displayed question 312 by entering the text in window 314. The SC can select default answers in window 316 or can select other answer options 328 (e.g., “multiple answers” or “add ‘Other’ answer choice) by clicking on the corresponding check box. In one embodiment, to simplify the survey creation process, the survey editor 140 displays a single survey question per screen.

FIG. 4A illustrates a screen 400 for controlling the use and selection of survey templates which are stored in the database 181. The survey templates include one or more questions pre-built from the plurality of question types. The SC can use a particular survey as is or can modify individual questions provided by the survey template. List 406 enumerates some of the survey templates available to be selected by the SC. The SC can narrow the selection of templates by using the FILTER drop down box 404. The collection of survey templates can be filtered by, for example, Most Popular, Customer Support, Events, Human Resources, or Product Development. The survey templates include, but not are limited to pre-built templates for:

Customer Satisfaction;

Product/Service Feedback;

Customer Satisfaction (NPS Rating);

Conference Feedback;

Training Feedback;

Workplace Feedback;

Newsletter Unsubscribe; and

Job Interview Feedback;

The use of a template is optional. The SC can also start a survey from scratch by selecting button 402.

FIG. 4B illustrates a screen 430 enumerating some of the question types available to be selected by the SC.

The question types include, but not are limited to: Multiple Choice 432a, Rating Scale 432b, Form 432c, Comment 432d, Comment 432d, Matrix of choices 432e and Instructions 432f. Other question types include Like/Dislike (Image), Rate (Image), Dichotomous (not shown).
The Multiple Choice 432a question type has the following options:
Single answer
Multiple answers
Add an “Other” answer option
   The Rating Scale 432b question type has the following options:
3 Point Rating Scale
Likert 5 Scale (a psychometric scale used in surveys)
NPS (Net Promoter Scale) 0-10 Scale
   The Form 432c question type has the following options:
With Form questions, the SC can add up to 5 different input fields and label them as desired.
   Comment 432d question type has the following options:
Options for Comment questions:
Limit response input to 420 characters
Unlimited characters
   Instructions 432f question type is useful for adding some additional information either about the survey in general or about some upcoming questions to give them specific context.

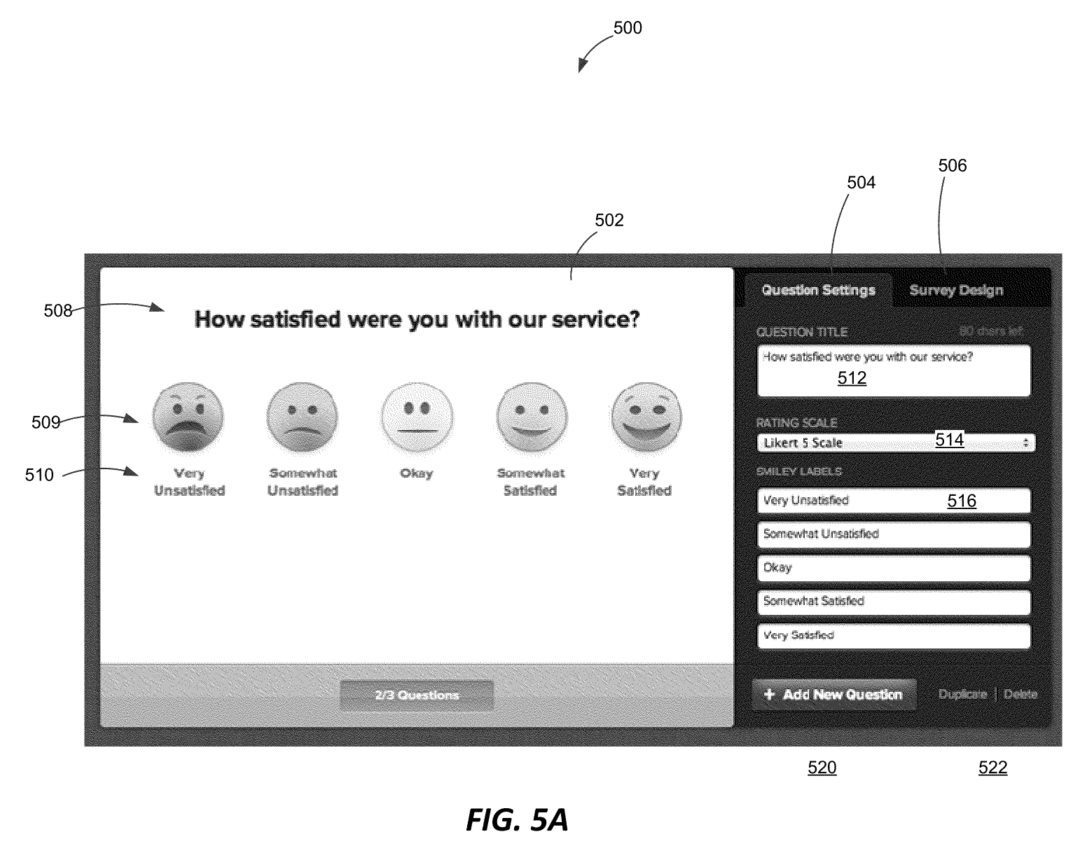

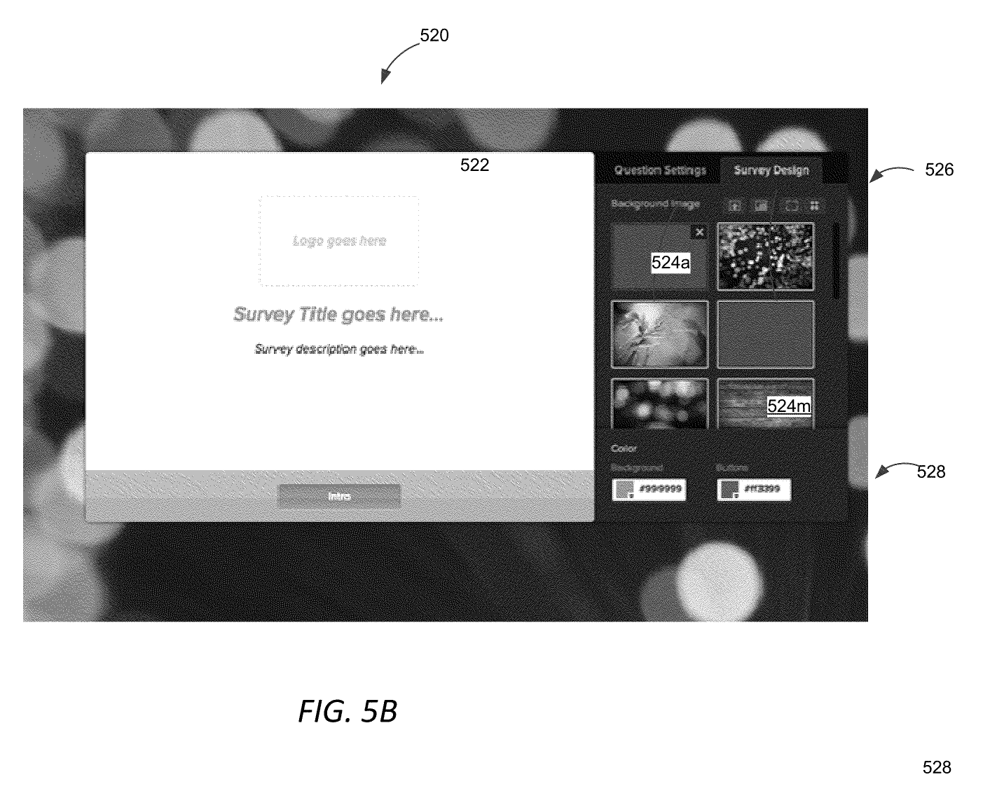

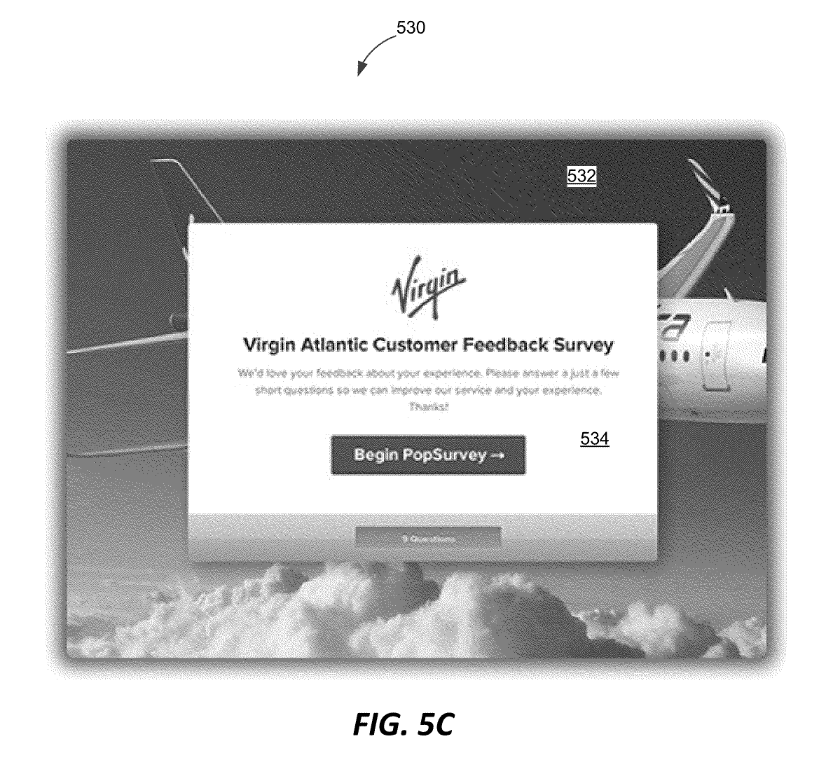

Now referring to FIGS. 5A-5C, further details of the survey editing process and graphical user interface are described. One of the question types in surveys produced by the survey system 110 is the smiley question where a series of smiley faces are presented with custom labels so the SC can create any type of satisfaction question he or she desires as shown in FIG. 5A.

The SC is able to provide a question title for the currently displayed question in window 502 by entering the text in window 512. Here the SC has chosen a Likert 5 Scale as displayed in the Rating Scale window 514. The SC can select default labels or modify the labels in window 516. The SC can use Question Settings tab 504 and Survey Design Tab 506 to modify the questions and design of the survey.

Here, in question shown in window 502, a question includes a title 508, a row of smiley faces 509 ranging in look from happy to sad corresponding to a row of labels 510 representing a rating scale. This question format provides a unique look to a survey question.

Now referring to FIG. 5B, a screen 520 is used to customize a default survey intro page 522 (also referred to as introduction page 522). The SC customizes the default survey intro page 522 using controls 526 and 528 and selecting one of several default backgrounds 524a-524m. The controls can for example set button colors. As shown in FIG. 5C the SC can also customize an intro page 530 with company logo 532 and additional company branding 534. Once the SC is happy with the survey, he or she can preview it from the editor. In addition to branding or customizing the intro and thank you pages, the survey editor 140 can incorporate user supplied branding to represent the user brand in survey questions.

Once the ST is done taking the survey, they are presented with a thank you slide with additional options. Depending on the configurations selected by the SC, the thank you slide can have a marketing message from survey system 110 to create a free account or be customized by the SC to have a desired appearance as in FIG. 5C. In another embodiment, the SC can configure the survey so that the ST is redirected to an SC specified URL upon survey completion of the Survey instead of showing the ST the thank you slide. The survey system allows the SC to see the survey as the ST would, but answers are not recorded in the database 181.

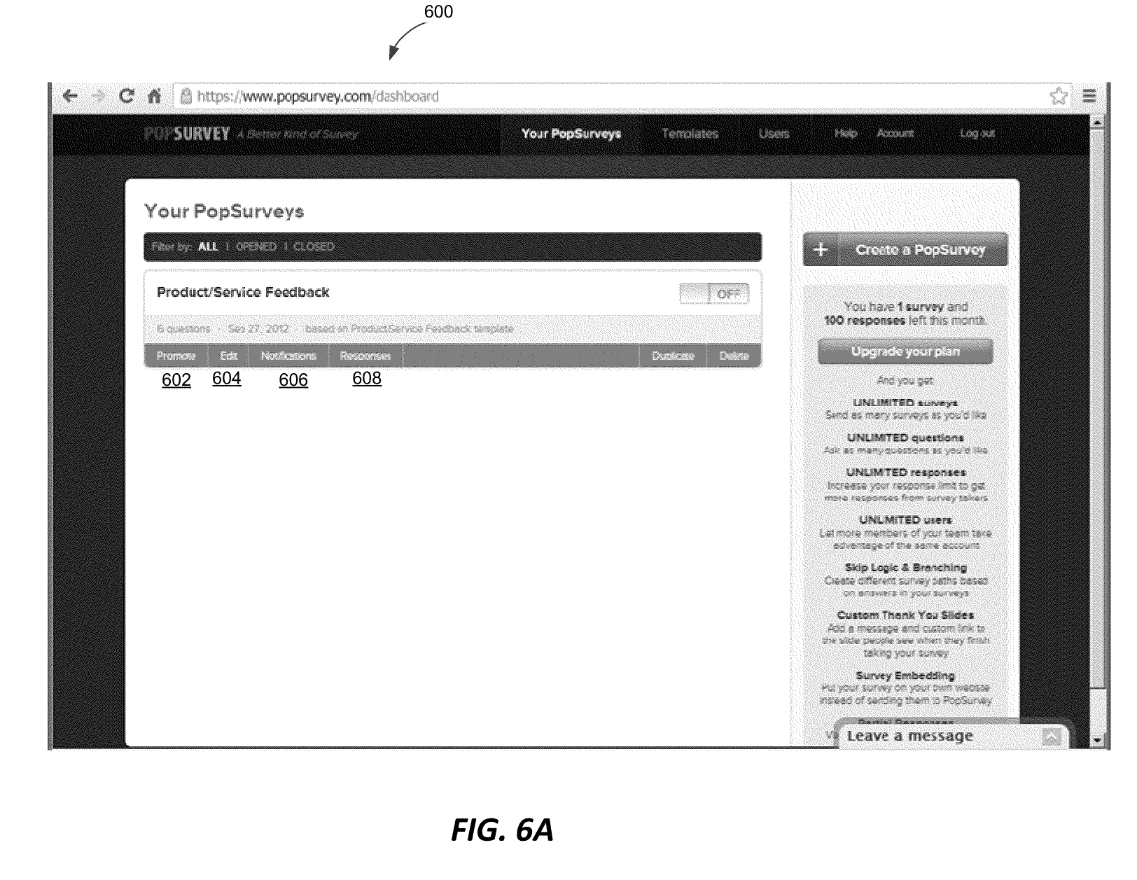

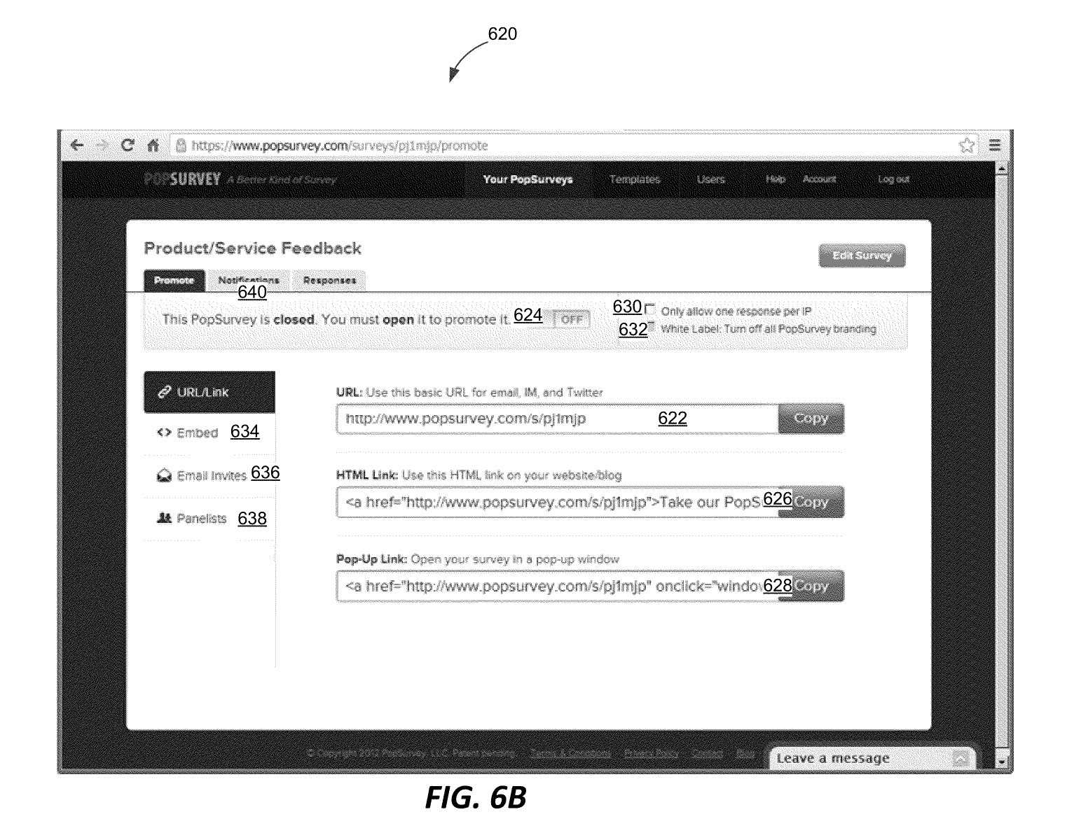

FIG. 6A is a screen shot of a dashboard control screen 600 which enables a survey creator (SC) to select tabs to edit 604, promote 602, receive notification 606 and to review responses 608 from a survey in accordance with embodiments of the invention; Now referring to FIG. 6B, promotion control screen 620 for each survey enables the SC to promote a completed survey (e.g., distribute the survey to a group of survey takers). The promotion control screen 620 can be accessed, for example, by clicking on a promote button in the dashboard control screen 600 or a promote link within each survey. The SC is able to promote a survey by copying a unique link that the survey system 110 automatically generates by using copy button 622. The SC can then email or otherwise provide this link to customers and others to take the survey. The promotion control screen 620 shows an option to turn the survey on or off (enable or disable) using button 624. The SC can also copy an HTML link for use on a Web site or blog page by using copy button 626. The SC can also copy a Pop-Up link for use in a pop-up window by using copy button 628. Using these options, the SC can promote the survey via Twitter and Facebook. For each survey created SCs can enable notifications for the responses they receive from survey takers using tab 640. They can choose to be emailed each time they receive a response or once a day in a “daily digest” type of email that summarizes the respones they've recieved in the previous 24 hours. In one embodiment, the survey system 110 automatically sends out these notifications via email. It is understood that survey responses can be view on both an aggregate level and an individual ST level.

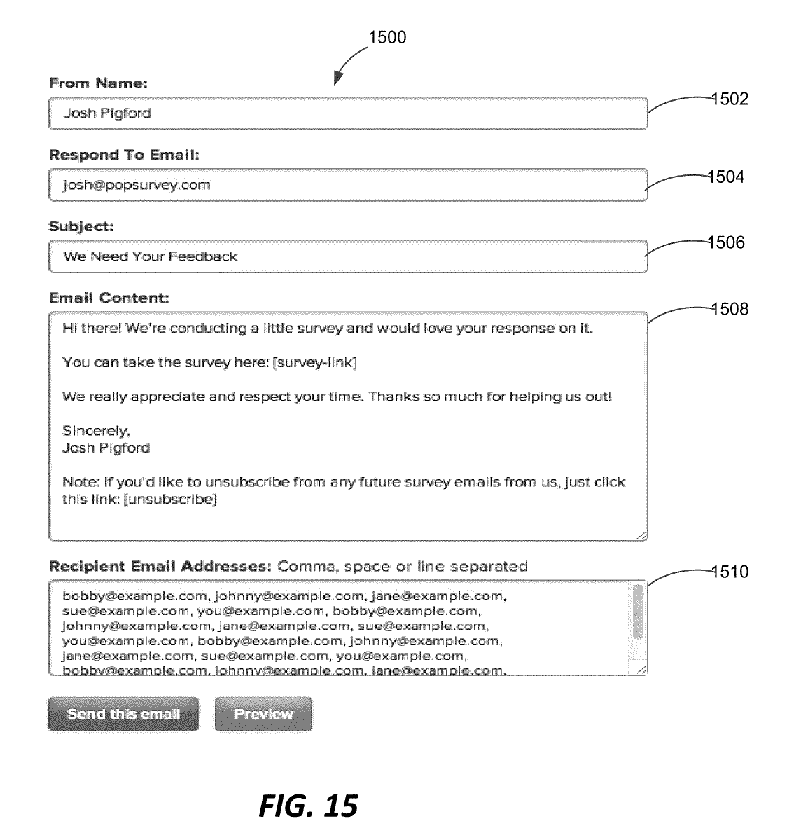

In an alternative embodiment, the SC can choose to embed the survey player 142 on their own website using button 634. The survey system provides a small line of HTML embed code that the SCs post on their site for ST to complete directly on their site instead of visiting a hosted survey system 110 web page. The SC can select that a panel of survey takers meeting certain selectable criteria is to be used for the survey and then the promote survey by selecting button 638. The use of Email invites, accessed by button 636, is described in further detail below in conjunction with FIG. 15.

The SC can limit the survey to only being taken once by the same person by clicking on the “Only allow one response per IP” check box 630. The SC can control branding options by clicking on check box 632.

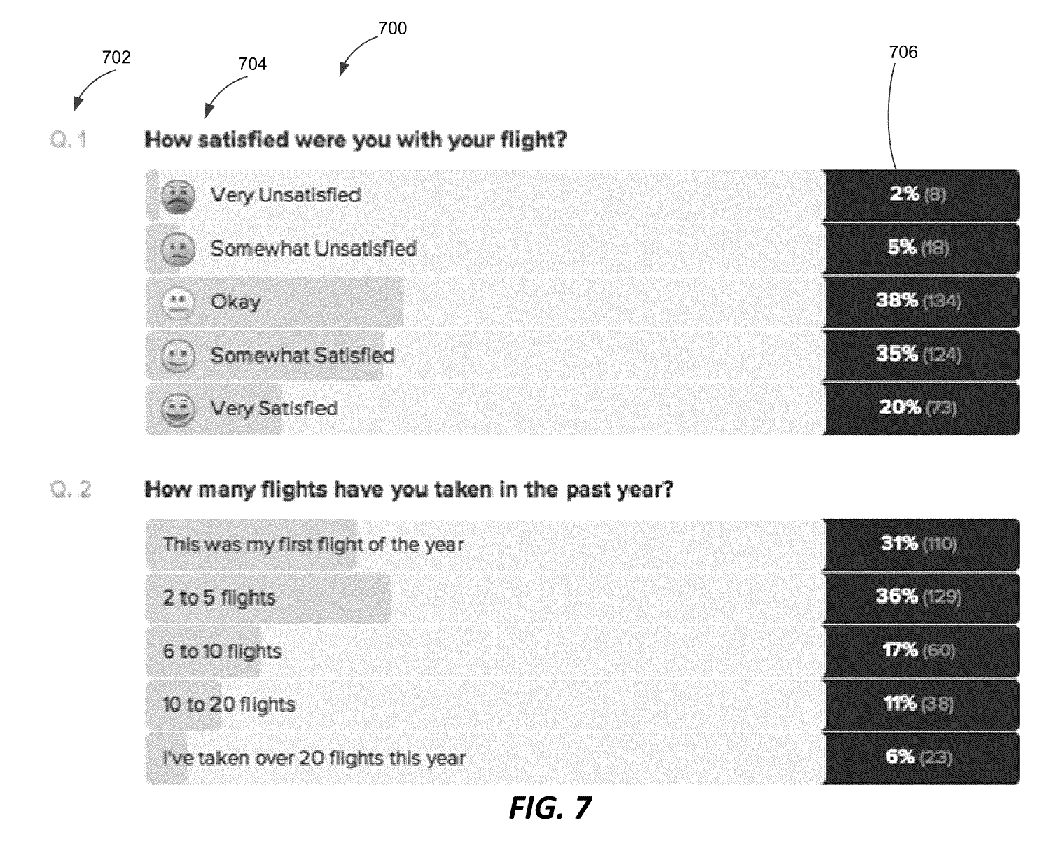

Now referring to FIG. 7, screen 700 illustrates an exemplary report from a survey. Seeing responses with survey system 110 is easy. The SC simply clicks “Responses” on the dashboard control screen 600 and is shown all the questions 702 along with the answers 704. The answers are stored in the central database 181 with the corresponding unique survey identifier and the ST' s responses 706 which are then displayed under the responses section for the survey to the SC. Responses are grouped under unique “response sets” that are generated when the user initially visits the survey's unique link. In one embodiment, the response set is based around the survey taker's IP address. SCs can also export the raw results data in CSV format.

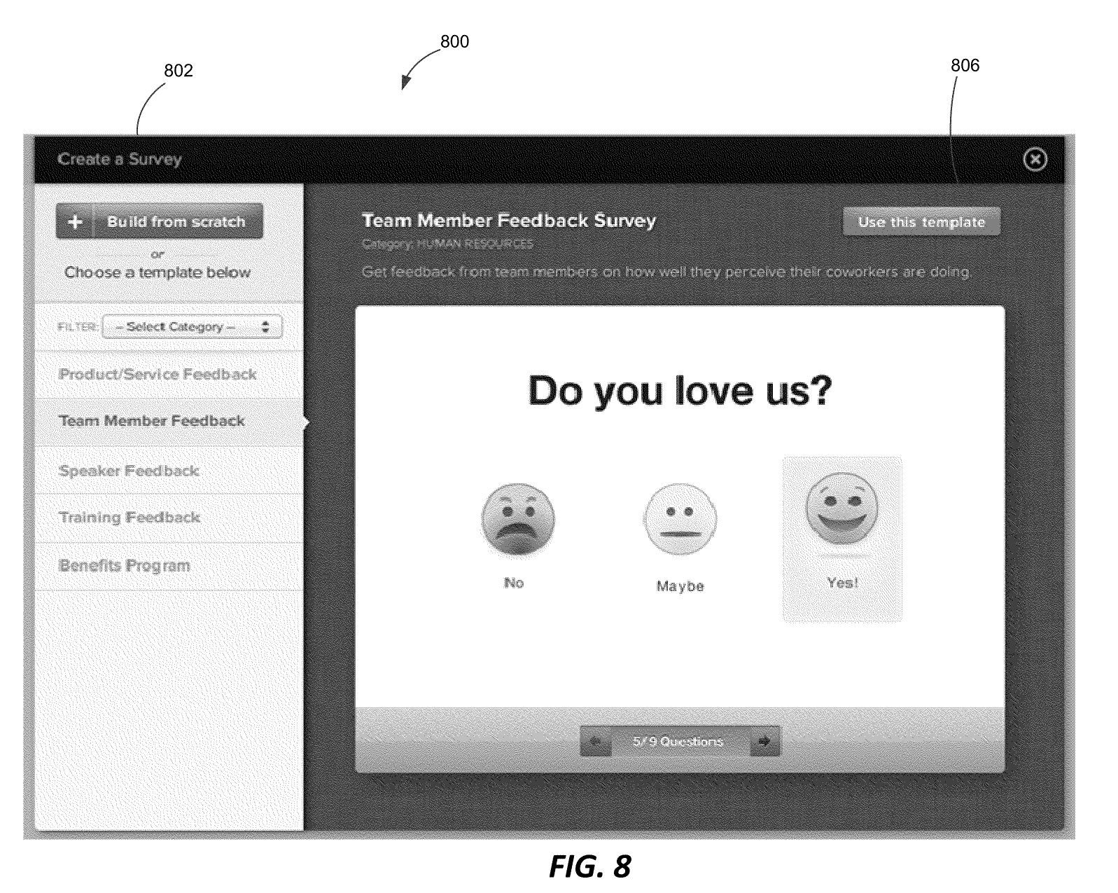

FIG. 8 is a screen shot of a question template 800 used in conjunction with of the survey editor 140. In addition to being able to create a survey from scratch, a SC can also choose from predefined templates. These predefined templates are comprised of pre-made questions stored in the database 181. The SC then clicks a single “Use this template” button and can then promote the survey as if they had created the survey themselves from scratch. When the SC clicks “Use this template,” button 806 the survey system 110 automatically generates a new survey including predefined questions associated with the selected template. It is understood that the SC can also customize the template to change the questions or add additional questions.

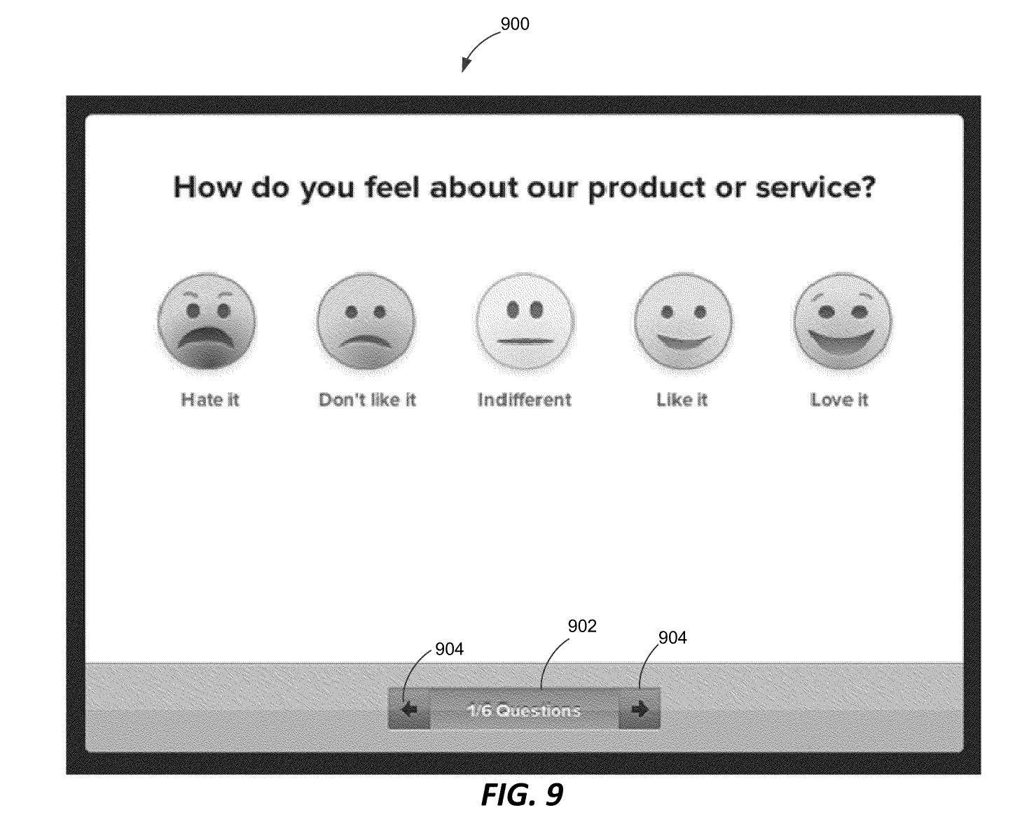

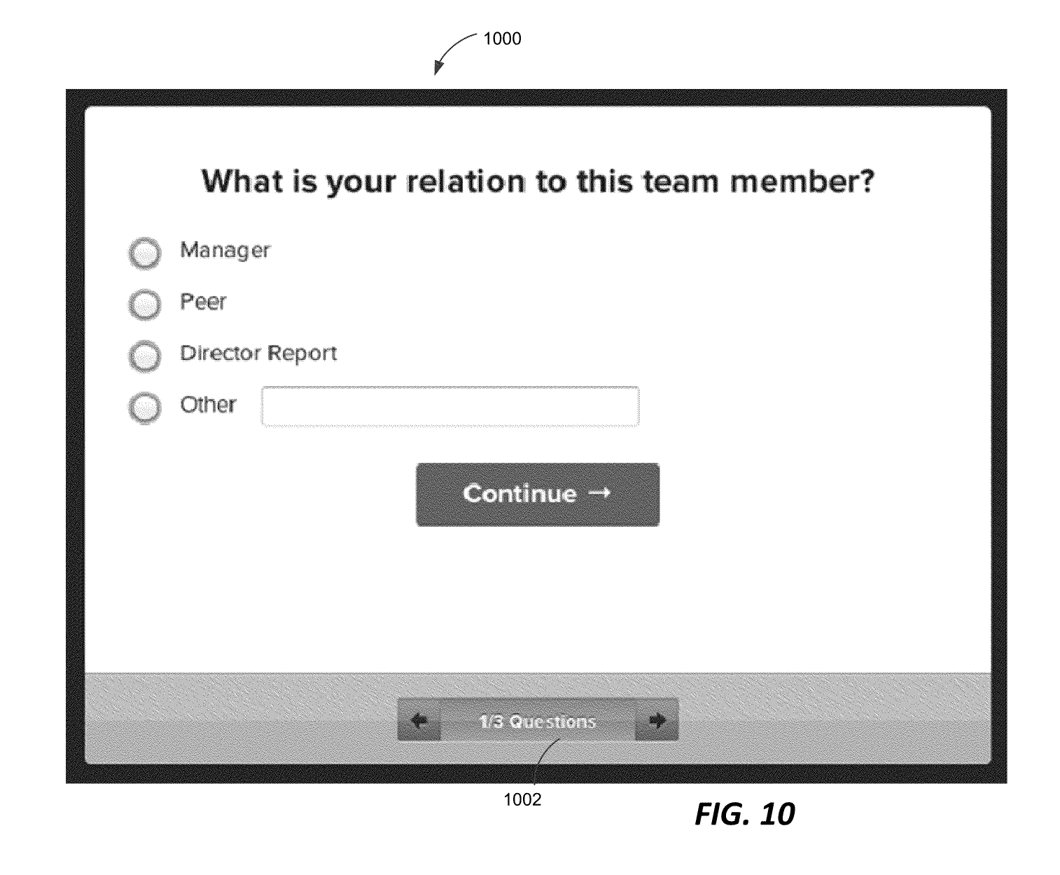

Now referring to FIG. 9, the survey system 110 facilitates completion of surveys by Survey Takers (ST) on the Survey Player 142. Unlike traditional surveys where all the questions are presented on single or multiple pages, the survey player 142 displays each question 900 individually, formatted and sized for the device being used by the ST. The ST answers a question and is shown the next question. The player includes arrow controls 904 as well as the current question number and total number of available questions in text box 902. When a survey is completed, the survey data is stored in the database 181. FIG. 10 illustrates another survey question 1000 as displayed on the survey player 142.

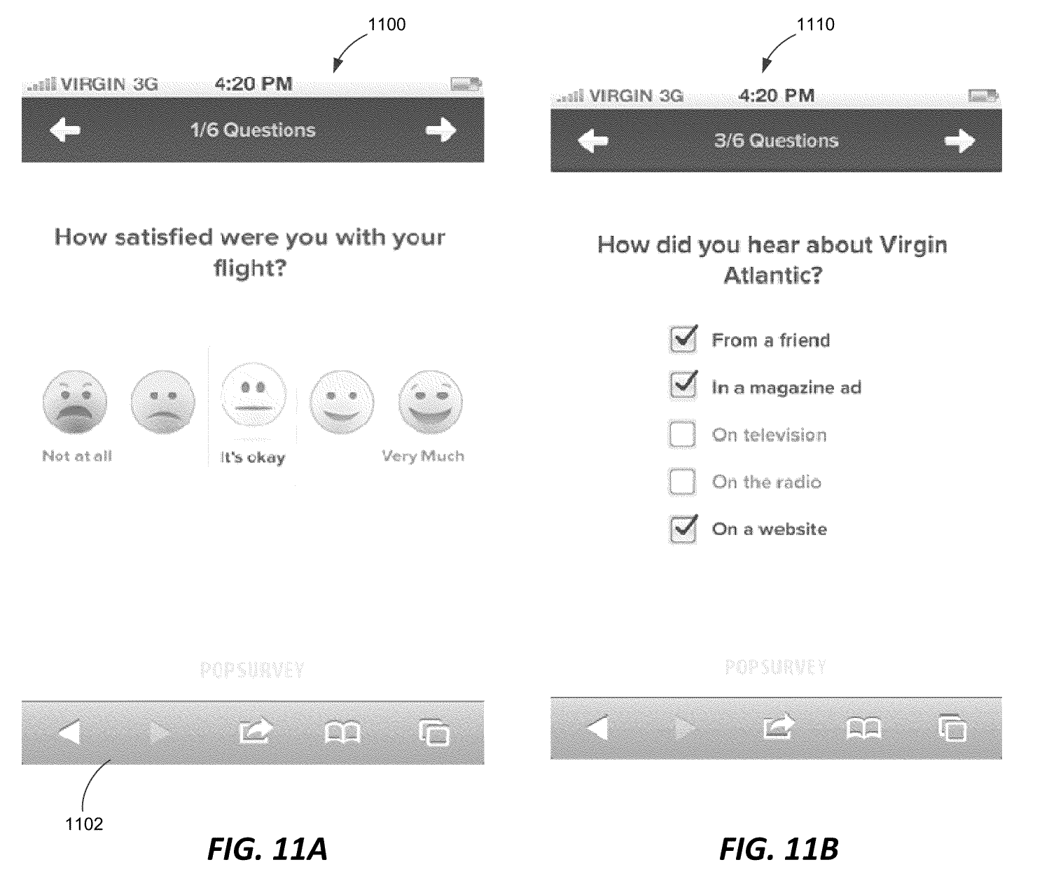

FIGS. 11A and 11B are screen shots 1100 and 1110 of survey questions as displayed on a mobile device using a survey player similar to the survey player 142 of FIG. 2. Here the survey player is optimized for collecting survey data from, for example a smartphone or iPhone. Survey takers on an iPhone or similarly-capable smartphone will be presented with a survey player optimized specifically for their display screens and input devices.

The ST can take the survey on a hosted page where the player is displayed on top of a custom background image picked by the SC. The hosted page is what the ST sees when visiting a unique survey system 110 supplied URL link. SCs can upload their own image or choose from default images supplied by the survey system 110.

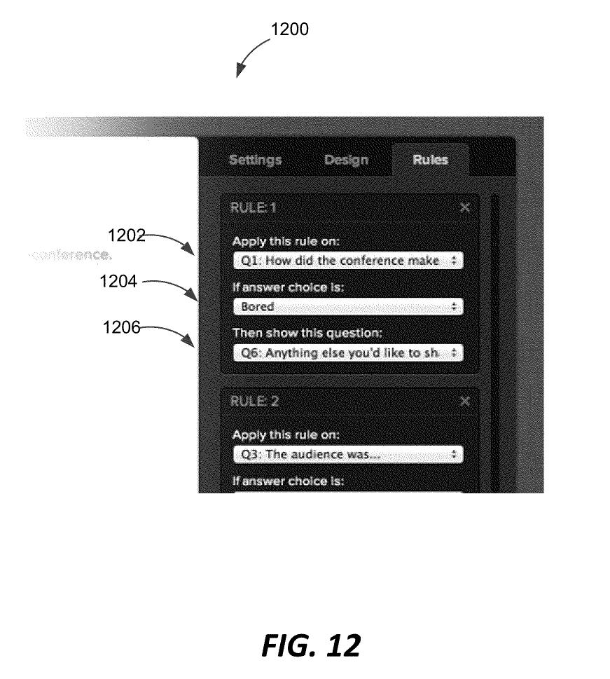

FIG. 12 is a screen shot of a rules control screen 1200 which enables a survey creator (SC) to implement skip-logic and branching. The survey editor 140 provides an interface for associating at least one rule with a survey question. Adding rules enabling skip logic and branching when a survey is taken on the survey player 142. This feature makes surveys more powerful and thorough without making the survey too complicated for survey takers. The survey player 142 executes skip logic and branching for the rules associated with a survey question. To enable a rule the SC simply selects a question using control 1202, specifies and answer choice using control 1204 and an action to take, for example, showing another question using control 1206.

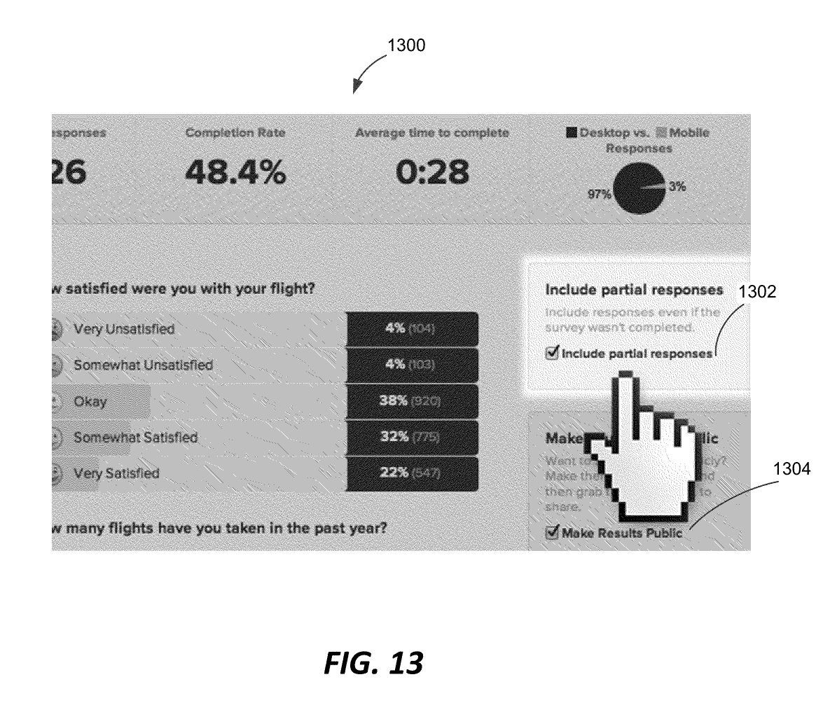

FIG. 13 is a screen shot 1300 of a survey response control page which enables the SC to view survey responses and select survey response options including an Include Partial Response Checkbox 1302 and a Make Results Public Checkbox 1304. Although the survey system 110 endeavors to keep surveys short in order to obtain higher completion rates, STs do not always complete the surveys. An ST might answer 9 out of 10 questions and many times it would still be helpful to know how the ST responded to those 9 questions, and survey system 110 facilitates retrieving that data by allowing the SC to click the check box 1302 to include data from partial responses in the compiled reports.

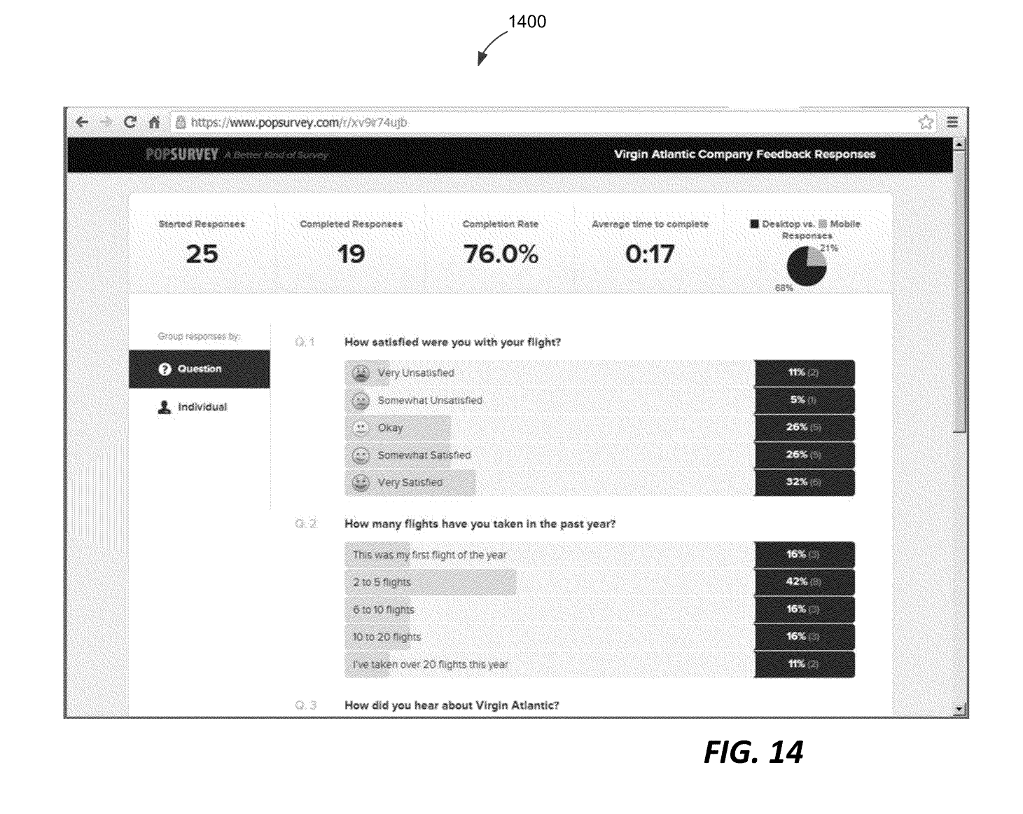

FIG. 14 is a screen shot 1400 of a public survey response enabled on a survey response control page. The survey system 110 enables the SC to share survey results with other members of their team, customers or other parties with a single click.

When a SC makes survey responses public (from the “Responses” area of each survey), the SC is given a unique URL just for sharing. Anyone who receives the URL from the SC will be able to see a read-only view of the survey responses.

FIG. 15 is a screen shot 1500 of an optional survey email control page which enables the SC to mail a survey link to a list of recipients. The survey creator provides a name 1502 and email address 1504, a recipient list 1510, and the survey system 110 supplies a default subject 1506 and email content 1508. The SC can customize the subject 1506 and email content 1508 but a full default email is initially provided by the survey system 110 so the SC is not required to provide customization. The survey system 110 inserts the email link (which automatically tracks the respondent's address when they respond) as well as the required Unsubscribe functionality to comply with various spam laws. In one embodiment using the defaults, the SC navigates to the Promote area of the survey, copies/pastes an email list and then clicks on a send button to distribute the survey.

Optionally, the SC can use Custom URL Variables to obtain additional information. These variables allow users to append additional ST data directly through a URL (e.g., a user id, or any other pertinent data) that will then be tracked and saved along with the ST response in database 181.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated. Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that the invention should not be limited to the described embodiments but rather should be limited only by the spirit and scope of the appended claims.

What is claimed is:

1. A survey system comprising
a database comprising plurality of survey question types;
a survey editor; and
a survey player.

2. The system of claim 1, wherein the survey editor displays a single survey question per screen.

3. The system of claim 1, wherein the survey editor incorporates user supplied branding to represent a user brand in a survey question.

4. The system of claim 1, wherein the survey editor limits the number of answer options included in a multiple choice type question and limits the length of survey answers.

5. The system of claim 1, wherein the survey editor provides an interface for associating at least one rule with a survey question and wherein the survey player executes skip logic and branching for the at least one rule associated with a survey question.

6. The system of claim 1, wherein the database further comprises a plurality of survey templates comprising at least one question pre-built from the plurality of question types.

7. The system of claim 1 further comprising providing a graphical user interface for integrated panel selection.

8. The system of claim 1, wherein the survey player is executable on a mobile device and survey questions are automatically reformatted and optimized for mobile device interaction.

9. A non-transitory computer readable medium comprising executable instructions encoded thereon operable on a computerized device to perform processing comprising:
receiving a request to create a survey from a survey creator;
providing a plurality of survey question types;
providing a graphical user interface for composing survey questions using at least one of the plurality of survey question types;
providing a graphical user interface for editing the survey questions in response to input from the survey creator; and
displaying the edited survey questions on a survey player.

10. A computer-implemented method for survey creation and distribution comprising:
receiving a request to create a survey from a survey creator;
providing a plurality of survey question types;
providing a graphical user interface for composing survey questions using at least one of the plurality of survey question types;
providing a graphical user interface for editing the survey questions in response to input from the survey creator; and
displaying the edited survey questions on a survey player.

11. The method of claim 10, wherein editing the survey questions further comprises
adding rules enabling skip logic and branching and wherein editing the survey further comprises integrating user supplied branding.

12. The method of claim 10, further comprising providing a plurality of survey templates comprising at least one question pre-built from the plurality of question types.

13. The method of claim 10, wherein graphical user interface for editing the survey questions presents a single question per screen to the survey creator.

14. The method of claim 10, wherein displaying the survey questions on a survey player further comprises executing skip logic and branching.

15. The method of claim 10 further comprising:
receiving an email list from a survey creator; and
sending email invites to participate in a survey to users on the email list.

16. The method of claim 10 further comprising:
collecting partial responses and
storing the partial responses for review.

17. The method of claim 10 further comprising providing a customizable thank you page.

18. The method of claim 17 further comprising:
redirecting a survey taker to a predetermined web site after displaying the thank you screen.

19. The method of claim 10 further comprising providing embed code to enable embedding the survey player on a web site of the survey creator.

20. The method of claim 10 further comprising automatically reformatting and optimizing edited survey questions for mobile device interaction.
